(19) United States
(12) Patent Application Publication
(10) Pub. No.: US 2008/0178474 A1
(43) Pub. Date: Jul. 31, 2008

(54) DROPPED POINT PUSH HOOK SKINNER KNIFE BLADE

(76) Inventors: John E. Spencer, Harper, TX (US); Russell P. Rogers, Harper, TX (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 11/840,513

(22) Filed: Aug. 17, 2007

Related U.S. Application Data
(60) Provisional application No. 60/887,371, filed on Jan. 31, 2007.

(51) Int. Cl. B26B 9/02

(52) U.S. Cl. 30/294; 30/161

(57) ABSTRACT

A dropped-point skinner knife blade is configured with an integral push-hook feature. This blade configuration creates a skinning knife that is well configured to allow the user to initiate and continue a cut within the skin of an animal carcass. It also allows the user to alternatively cut the skin with a push-hook configuration whereby the user is “pushing” the blade away from the user in a must safer fashion as opposed to pulling the blade towards the user.

This application claims the benefit and priority of U.S. Provisional Patent Application No. 60/887,371 filed Jan. 31, 2007.

### FIELD OF THE INVENTION

This invention relates generally to cutting tools and knives. More particularly, it relates to a knife blade that is particularly configured for use with cutting and skinning game and the like.

### BACKGROUND OF THE INVENTION

Cutting tools have been used since the Stone Age, when our primal ancestors first used flint or other rock, chipped or ground to an edge to cut and carve all sorts of materials. Early man later discovered that shards of glass-like obsidian stone could be used with even greater cutting ability. Knives of this type were used with and without primitive handles.

During the Bronze Age, advances in metallurgical smelting and forging led to man's discovery that he could form bronze and iron into sharp blades for similar tools and weapons. As materials and designs continued to change, modern man has developed knives from steel and other much-improved materials, including tempered high-carbon ferrous alloys using chromium, molybdenum, niobium and vanadium.

In general, knives can be categorized as fighting knives or working knives. Some knives can function as both. Working knives tend to be designed for a particular activity or occupation. For example, the development of the working kitchen knife has lead to the production of everyday special-use knives for spreading food products (the butter knife), knives for cutting large pieces of meat (the carving knife), for cutting bread without compressing it in a saw-like fashion (the bread knife), and so on.

Another area where working knives have developed is in the area of special-purpose knives that are used in the once-necessary, but now mostly recreational, sport of hunting. This is the art in which the knife blade of the present invention is intended to be practiced.

As a further preliminary matter, recreational knives can be categorized into fixed-blade knives and folding knives. Which is used as a matter of convenience, functionality and personal preference of the user. A fixed-blade knife is connected to its handle as an extension of it. A folding knife, on the other hand, is capable of storing the blade within the handle. While a fixed-blade and a folding knife concept are each presented here, it is to be understood that the present invention is not limited in application to either configuration.

It is also known in the art that there are a variety of knife blade shapes. For example, a curved, or trailing-point, knife blade has a back edge that curves upwardly. A normal blade, on the other hand, would have a curved edge and a substantially flat and dull back. The dull back allows the user to apply blunt force to the dull knife back to assist in cutting objects by concentrating additional force downwardly at a specific point on the blade. The normal blade knife is typically a heavy knife compared to other knife blade shapes. For example, the curved, trailing-point, knife blade allows a lightweight knife to have a larger curve on its edge. A clip-point blade is similar to a normal blade, but with the back “clipped” to make the tip thinner and sharper. This sharp tip is useful as a pick. The famous “Bowie” knife is a clipped blade knife. Another shape is the dropped-point knife blade, which is similar to a clip-point blade, but features the back being convexly-formed downwardly, rather than having a “clip” taken out of it, the clip-point blade having a back that is concavely-formed to make the tip thinner and sharper as mentioned above.

In the view of these inventors, there is a need for a new, useful and non-obvious improved knife blade design that utilizes a dropped-point knife blade that is combined with a push hook feature. This blade combination would create a skinning knife that would be well configured to allow the user to initiate and continue a cut within the skin of an animal carcass, but would also allow the user to alternatively cut the skin with a push hook configuration.

### SUMMARY OF THE INVENTION

It is, therefore, a principal object of this invention to provide a new, useful, and non-obvious improved knife blade design that utilizes a dropped-point knife blade that is combined with a push hook feature. It is another object of this invention to provide such a blade configuration that creates a skinning knife whereby the user can easily initiate and continue a cut within the skin of an animal carcass by using the dropped-point blade portion of the knife blade. It is still another object of this invention to provide an integrally-formed push hook configuration within the same knife blade to alternatively cut the skin with this push hook configuration. It is yet another object of the present invention to provide a knife blade configuration that is safer to use than prior art knife blades. It is still another object of this invention to provide such a novel knife blade that can be incorporated within either a fixed blade knife or a folding knife.

The present invention has obtained these objects. In a first preferred embodiment, it provides for a dropped-point knife blade that is configured with an integral push hook feature. This blade configuration creates a skinning knife that is be well configured to allow the user to initiate and continue a cut within the skin of an animal carcass. It also allows the user to alternatively cut the skin with a push hook configuration, whereby the user is “pushing” the blade away from the user in a much safer fashion as opposed to pulling the blade towards the user.

The foregoing and other features of the dropped-point push hook skinner knife blade that is constructed in accordance with this invention will be apparent from the detailed description that follows.

### BRIEF DESCRIPTION OF THE DRAWINGS

FIG. 1 is a top, front and right side perspective view of a first preferred embodiment of a knife having a dropped-point push hook skinner knife blade that is constructed in accordance with the present invention.

FIG. 2 is a right side elevational view of the knife blade illustrated in FIG. 1 and showing the handle elements being removed from the tang.

FIG. 3 is a right side elevational view of a similar knife blade of prior art.

FIG. 4 is an enlarged partial right side elevational view of the knife blade shown FIG. 2.

FIG. 5 is an enlarged partial right side elevational view of the prior art knife blade shown in FIG. 3.

FIG. 6 is right side elevational view of a second preferred embodiment of a folding knife having a dropped-point push hook skinner knife blade that is constructed in accordance with the present invention and showing the blade in its “open” position.

FIG. 7 is a right side elevational of the folding knife illustrated in FIG. 6 and showing the knife blade in its folded or “closed” position.

### DETAILED DESCRIPTION

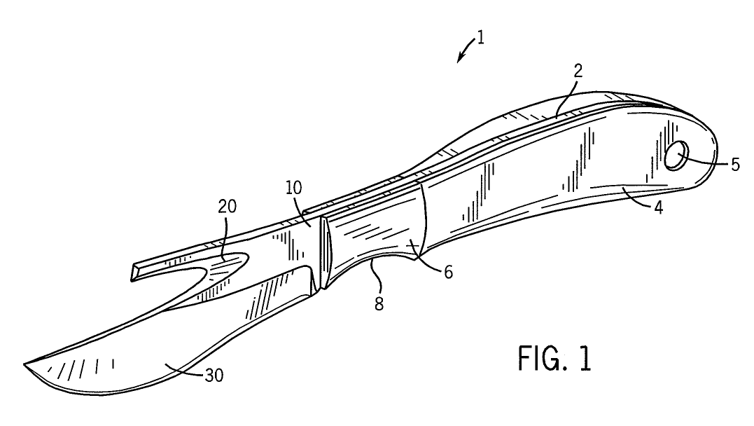

Referring now to the drawings in detail, wherein like numbered elements refer to like elements throughout, FIG. 1 illustrates a first preferred embodiment of a dropped-point push hook skinner knife blade, generally identified 10, which is constructed in accordance with the present invention and incorporated into a knife, generally identified 1.

As shown, the knife blade 10 includes a tang 2 which is an extension of the blade 10 into a handle 5. As shown, a hole 5 in the end of the handle 4 allows the knife 1 to be hung or placed on a lanyard (not shown). Towards the blade-end of the handle 4 is a bolster 6 which helps in joining the blade 10 to the handle 4 and adds strength to the knife 1. The bolster 6 includes a recess 8 which allows the user to enhance his or her gripping of the knife 1.

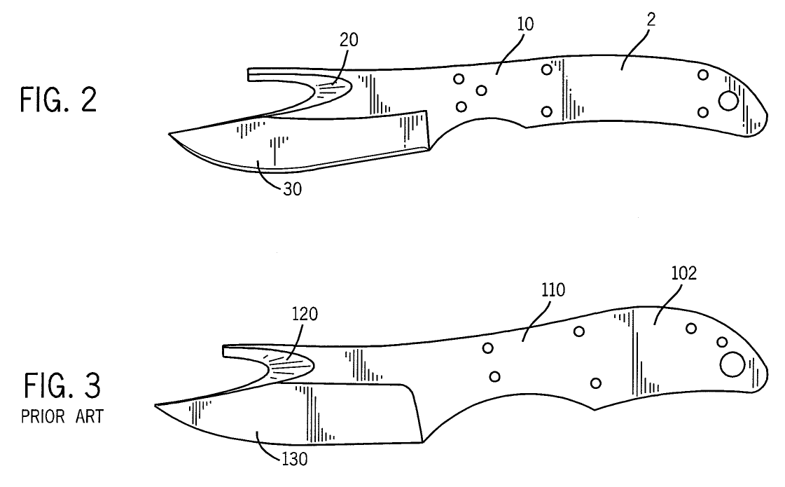

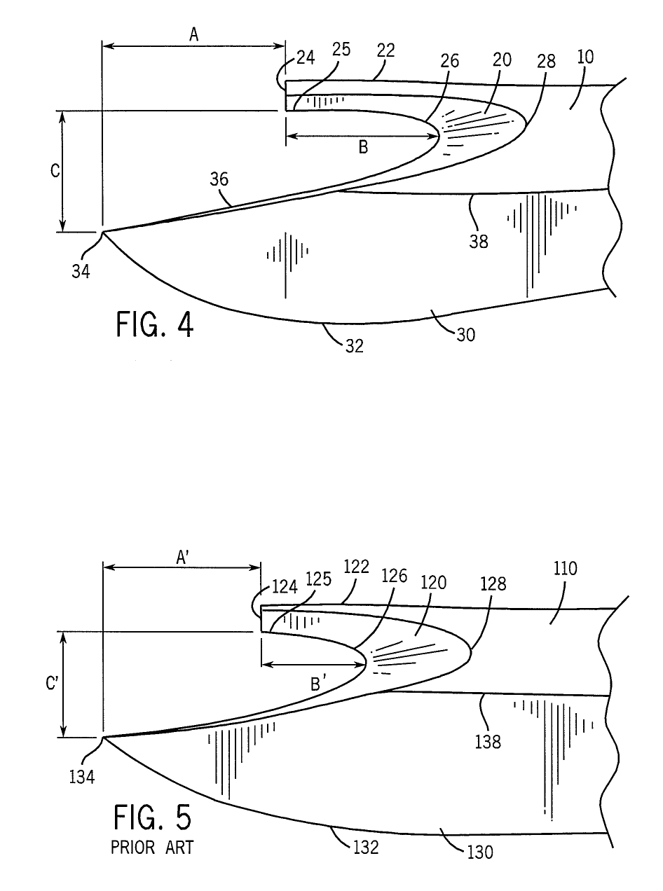

The knife blade 10 includes two key features as previously alluded to in this description. The first is the “push hook” portion 20 which is situated generally atop the knife blade 10 when the blade 10 is set in a generally horizontal position with the blade 10 being oriented vertically. The second is the “dropped-point” blade portion 30 which is situated below and forwardly of the push hook portion 20. Referring now to FIGS. 2 and 4, the shapes of the knife blade portions 20, 30 are illustrated in greater detail. In these figures, the tang 2 is shown without the handle attached, it being understood that the precise configuration or type of handle used not being a limitation of the present invention. That is, the knife blade 10 of the present invention could be used with a wide variety of handles without deviating from the scope of this invention.

As shown in FIGS. 2 and 4, it will be seen that the upper push hook portion 20 comprises a dull top edge 22, a forward-most point 24 and an inner blade edge 26. The inner blade edge 26 is formed in a substantially parabolic shape that ends in a parabolic taper line 28, the parabolic taper line 28 being positioned rearwardly of the inner blade edge 26.

It will also be seen that the lower dropped-point blade portion 30 comprises a bottom blade edge 32, a forward-most point 34 and a top blade edge 36. The top blade edge 36 of the dropped-point blade portion 30 is continuous with the lower most edge of the inner blade edge 26 of the push hook portion 20 of the blade 10. The dropped-point blade portion 30 also includes a more linear taper line 38 that is disposed generally above the bottom blade edge 32 and intersects the top blade edge 36 thereof.

As shown in FIG. 4, three dimensions or distances are illustrated for purposes of comparing the knife blade 10 of the present invention with the prior art. Specifically, the first dimension A is shown to illustrate the distance between the forward-most point 24 of the push hook blade portion 20 and the forward-most point 34 of the dropped-point blade portion 30. Additionally, the second distance B represents the distance from the forward-most point 24 of the push hook blade portion 20 and rearward-most edge of the inner blade edge 26 of the push hook blade portion 20. A third dimension C is illustrated to show the distance between the forward-most portion 34 of the dropped point blade portion 30 relative to the horizontal as compared to the bottom-most portion of the point 24, below which extends an edge 25.

It should also be mentioned at this point that the push hook blade portion 20 is a feature of the present invention that allows the knife blade 10 to be used in a much safer fashion than conventional “pull hook” designed knife blades (not shown). Although the pull hook concept is a popular one in the experience of these inventors, it is a far more dangerous design. Using a knife blade 10 with the push hook blade portion 20 allows the user to cut in a direction that is “away” from the user, whereas using a pull hook designed knife blade cuts in a direction that is “towards” the user when the user is pulling such a blade towards himself or herself. The knife blade 10 of the present invention totally eliminates that cutting danger and further distinguishes the knife blade 10 from the prior art.

Referring now to FIGS. 3 and 5, the details of a knife blade, generally identified 110, constructed in accordance with the prior art is shown. As a matter of record for purposes of this disclosure, the prior art knife blade 110 is a configuration originated by one of these inventors as well. As shown, the prior art knife blade 110 also comprises a push hook portion 120 and a curved, trailing point knife blade portion 130 that curves upwardly. The upper push hook portion 120 of the prior art knife blade 110 comprises a dull top edge 122, a forward-most point 124 and an inner blade edge 126. The inner blade edge 126 is formed in a generally parabolic shape that ends in a parabolic taper line 128, the parabolic taper line 128 being positioned rearwardly of the inner blade edge 126.

It will also be seen that the curved, trailing point knife blade portion 130 comprises a bottom blade edge 132, a forward-most point 134 and a top blade edge 136. The top blade edge 136 is continuous with the lower most edge of the inner blade edge 126 of the push hook portion 120 of the blade 110. The curved, trailing point knife blade portion 130 also includes a linear taper line 138 that is disposed above the bottom blade edge 132.

As shown in FIG. 5, three dimensions or distances are similarly illustrated for purposes of comparing this knife blade 110 with the knife blade 10 of the present invention. That is, the first dimension A′ is shown to illustrate the distance between the forward-most point 124 of the push hook blade portion 120 and the forward-most point 134 of the curved, trailing point knife blade portion 130. Additionally, the second distance B′ represents the distance from the forward-most point 124 of the push hook blade portion 120 and rearward-most edge of the inner blade edge 126 of the push hook blade portion 120. A third dimension C′ is illustrated to show the distance between the forward-most portion 134 of the curved, trailing point knife blade 130 relative to the horizontal as compared to the bottom-most portion of the point 124, below which extends an edge 125.

By comparing FIGS. 4 and 5, it is apparent that the dimension A is longer than the dimension A′; that the dimension B is longer than the dimension B′; and that the dimension C is longer than the dimension C′. This means, respectively, that the forward-most point 24 of the push hook portion 20 in the knife blade 10 of the present invention is set further back from its prior art counterpart; that the inner blade edge 26 of the push hook portion 20 is set much further back from its prior art counterpart, thus creating a substantially larger “hook” within which to capture the hide that is to be cut; and that the point 34 of the dropped-point blade portion 30 dips down, in a dropped-point fashion, to a point that is significantly lower than its counterpart in the prior art blade 110. The use of the dropped-point blade 30 also increases the capturing ability of the push hook portion 20 of the knife blade 10 which can actually be impeded by use of the curved, trailing point knife blade 130 of the prior art. Each of these features is known to these inventors, by their personal use and experience, to enhance and improve performance of the knife blade 10 of the present invention when used as intended in the field.

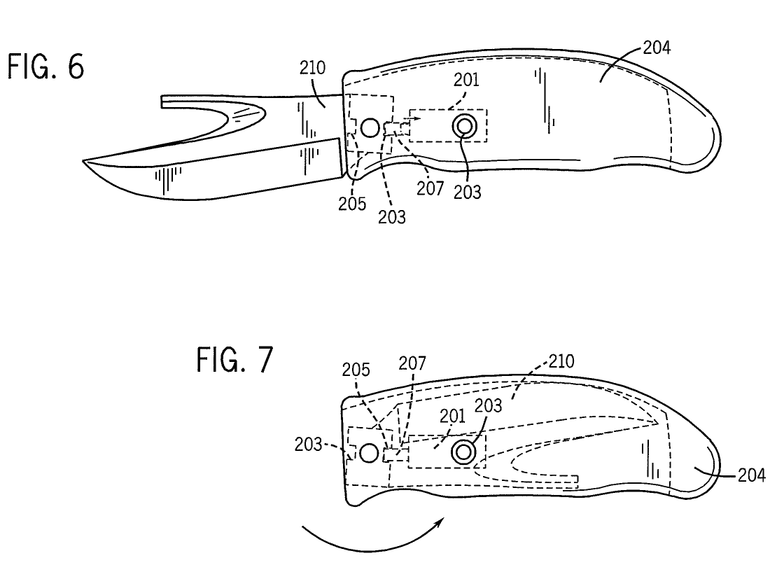

Referring now to FIGS. 6 and 7, a second preferred embodiment of the knife blade, generally identified 210, is shown. This embodiment of knife blade 210 comprises a dropped-point push hook skinner knife blade profile of its fixed blade counterpart shown in FIGS. 1, 2 and 4. The folding knife blade 210 includes a handle 204 having a locking mechanism. In this particular embodiment, the locking mechanism is in the form of a lockback device 201 consisting of a spring-loaded button 203 that, when depressed, releases a catch 207, the catch 207 engaging one of two notches 203, 205 defined within the tang 202 of the blade 210. In this fashion, the pivotally-mounted blade 210 can be secured in the “open” position as shown in FIG. 6, or in the “closed” position as shown in FIG. 7. It is to be understood that other locking mechanisms and devices could be used without deviation from the scope of the present invention.

In view of the foregoing, it will be seen that there have been provided in this disclosure several embodiments of a new, useful, non-obvious and uncomplicated knife blade design that utilizes a dropped-point knife blade that is combined with a push hook feature; that creates a skinning knife whereby the user can easily initiate and continue a cut within the skin of an animal carcass by using the dropped-point blade portion of the knife blade; that provides an integrally-formed push hook configuration within the same knife blade to alternatively cut the skin with this push hook configuration; and that provides such a novel knife blade that can be incorporated within either a fixed blade knife or a folding knife.

The details of the invention having been disclosed in accordance with: the foregoing, we claim:

1. A skinner knife blade comprising
a push-hook portion, the push-hook portion being situated generally atop the knife blade, and
a dropped-point blade portion, the dropped-point blade portion being situated below and forwardly of the push-hook portion.

2. The skinner knife blade of claim 1 wherein the push-hook portion further comprises a dull top edge, a forward-most point and an inner blade edge wherein the inner blade edge is formed in a substantially parabolic shape that ends in a parabolic taper line, the parabolic taper line being positioned rearwardly of the inner blade edge.

3. The skinner knife blade of claim 2 wherein the lower dropped-point blade portion further comprises a bottom blade edge, a forward-most point, and a top blade edge, the top blade edge being continuous with a lower-most edge of the inner blade edge of the push-hook portion of the blade.

4. The skinner knife blade of claim 3 wherein the dropped-point blade portion further comprises a linear taper line that is disposed generally above the bottom blade edge and intersects the top blade edge thereof.

5. The skinner knife blade of claim 3 wherein the distance between the forward-most point of the push-hook blade portion and the forward-most point of the dropped-point blade portion comprises a dimension, said dimension being greater than the same dimension in knives of the prior art.

6. The skinner knife blade of claim 3 wherein the forward-most point of the push-hook blade portion and the rearward-most edge of the inner blade edge of the push-hook blade portion comprises a dimension, said dimension being greater than the same dimension in knives of the prior art.

7. The skinner knife blade of claim 3 wherein the distance between the forward-most portion of the dropped-point blade portion relative to the horizontal as compared to the bottom-most portion of the point below which extends an edge comprises a dimension, said dimension being greater than the same dimension in knives of the prior art.

8. The skinner knife blade of claim 3 further comprising a knife tang, said knife tang being configured for fixation within a handle.

9. The skinner knife blade of claim 8 further comprising a locking mechanism whereby the blade can be pivotally-mounted within a handle and can be alternatively secured in an “open” position or in a “closed” position.

10. A skinner knife blade comprising
a push-hook portion, the push-hook portion being situated generally atop the knife blade when the blade is held in a horizontal position with the blade being oriented vertically, and
a dropped-point blade portion, the dropped-point blade portion being situated below and forwardly of the push-hook portion.

11. The skinner knife blade of claim 10 wherein the push-hook portion further comprises a dull top edge, a forward-most point and an inner blade edge wherein the inner blade edge is formed in a substantially parabolic shape that ends in a parabolic taper line, the parabolic taper line being positioned rearwardly of the inner blade edge.

12. The skinner knife blade of claim 11 wherein the lower dropped-point blade portion further comprises a bottom blade edge, a forward-most point, and a top blade edge, the top blade edge being continuous with a lower-most edge of the inner blade edge of the push-hook portion of the blade.

13. The skinner knife blade of claim 12 wherein the dropped-point blade portion further comprises a linear taper line that is disposed generally above the bottom blade edge and intersects the top blade edge thereof.

14. The skinner knife blade of claim 12 further comprising a knife tang, said knife tang being configured for fixation within a handle.

15. The skinner knife blade of claim 14 further comprising a locking mechanism whereby the blade can be pivotally-mounted within a handle and can be alternatively secured in an “open” position or in a “closed” position.
